(19) United States
(12) Patent Application Publication
(10) Pub. No.: US 2015/0204170 A1
(43) Pub. Date: Jul. 23, 2015

(54) SINGLE WELL INJECT-PRODUCE PILOT FOR EOR

(71) Applicants: SCHULMBERGER TECHNOLOGY CORPORATION, Sugar Land, TX (US); SHELL OIL COMPANY, Houston, TX (US)

(72) Inventors: Cosan Ayan, Clamart (FR); Omer M. Gurpinar, Denver, CO (US); Daniel Palmer, Versailles (FR); Albert Hendrik De Zwart, Horn (NL); Cornelius Petrus Josephus Walthera Van Kruijsdijk, Delft (NL); Diederik Michiel Boersma, Den Haag (NL); Paul Marie te Riele, Den Haag (NL); John Justin Freeman, Pattison, TX (US)

(21) Appl. No.: 14/419,208

(22) PCT Filed: Aug. 1, 2013
(86) PCT No.: PCT/US2013/053120

§ 371 Date: Feb. 2, 2015

Related U.S. Application Data
(60) Provisional application No. 61/678,250, filed on Aug. 1, 2012.

(51) Int. Cl. E21B 43/16; E21B 43/24; C09K 8/58; E21B 43/12; E21B 41/00; E21B 47/00; E21B 43/20

(52) U.S. Cl. CPC E21B 43/16; E21B 47/00; E21B 43/164; E21B 43/168; E21B 43/166; E21B 43/24; E21B 43/20; E21B 43/121; E21B 41/0092; C09K 8/58

(57) ABSTRACT

Injecting an enhanced oil recovery (EOR) agent into a subterranean formation in at least one injection interval of a hydrocarbon well extending into the subterranean formation, then producing fluid from the formation from at least one production interval of the same hydrocarbon well, and not from a neighboring well. Logging data associated with at least one of the formation, the injected EOR agent and the produced fluid may then be obtained and utilized in assessing effectiveness of the EOR agent injection.

### BACKGROUND OF THE DISCLOSURE

As hydrocarbon fields are growing more mature, the established methods of producing oil are no longer sufficient to exploit a reservoir to the extent theoretically possible. Thus, new methods have been proposed to increase recovery beyond that afforded by established methods. These methods are generally referred to as “Enhanced Oil Recovery” or EOR treatments.

### SUMMARY OF THE DISCLOSURE

The present disclosure introduces a method comprising injecting an EOR agent into a subterranean formation in at least one injection interval of a hydrocarbon well extending into the subterranean formation. Fluid is then produced from the formation from at least one production interval of the hydrocarbon well, and logging data associated with at least one of the formation, the injected EOR agent, and the produced fluid is obtained. The effectiveness of the EOR agent is then assessed based on the obtained logging data.

The present disclosure also introduces a system comprising means for injecting an enhanced oil recovery (EOR) agent into a subterranean formation in at least one injection interval of a hydrocarbon well extending into the subterranean formation, means for producing fluid from the formation from at least one production interval of the hydrocarbon well, and means for obtaining logging data associated with at least one of the formation, the injected EOR agent, and the produced fluid. The system further comprises means for assessing effectiveness of the EOR agent based on the obtained logging data.

The present disclosure also introduces an apparatus comprising a completion installed in a single hydrocarbon well extending into a subterranean formation. The completion comprises an uphole completion comprising a plurality of perforations for injecting an EOR agent pumped from surface into the subterranean formation, and a downhole completion comprising a plurality of perforations for producing fluid from the subterranean formation in response to injection of the EOR agent.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flow-chart diagram of at least a portion of a method according to one or more aspects of the present disclosure.

FIG. 2 is a schematic view of apparatus according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

EOR treatments within the scope of the present disclosure may comprise injecting surfactants and/or other chemicals and/or gas (e.g., methane, nitrogen, and/or carbon dioxide, among others) together or alternating with water injection, among other injected agents. However, EOR treatments often require thorough testing prior to large scale implementation in a reservoir. Conventionally, such testing has been limited to laboratory tests and field pilot tests.

For a laboratory test, an enclosed rock core is subjected to the EOR method to be tested. However, it may be difficult to emulate downhole conditions in the laboratory, such that the results of such core flooding tests may only be a general indicator of the efficacy of the tested EOR method.

In contrast, field pilot tests may permit testing under real downhole conditions. Such pilot tests may utilize, for example, one testing injector well and a small number of producing wells in the vicinity of the injector well, also known as a “five-spot” pattern. The distance between the wells may be less than about 100 m, and perhaps as small as about 3 m to about 10 m. The length of the active section may be less than about 1000 m, and perhaps as small as about 10 m to about 100 m, as needed to ensure that any heterogeneity in the reservoir is sufficiently averaged for the purpose of the testing. Nonetheless, even if the distance between two separate wells is minimal, typical permeability values of the rock formation between the wells may require the elapse of several years before for effectiveness of the tested EOR treatment becomes measurable. Such pilot tests may also require significant up-front investment in materials and equipment prior to having complete knowledge of the efficacy of the EOR treatment in question. Attempts at shortening the time required to test an EOR treatment have included using laterals or fractures within a well and, alternatively, placing sensors in micro-boreholes drilled from the main well. However, drilling costs may often render these alternatives impractical.

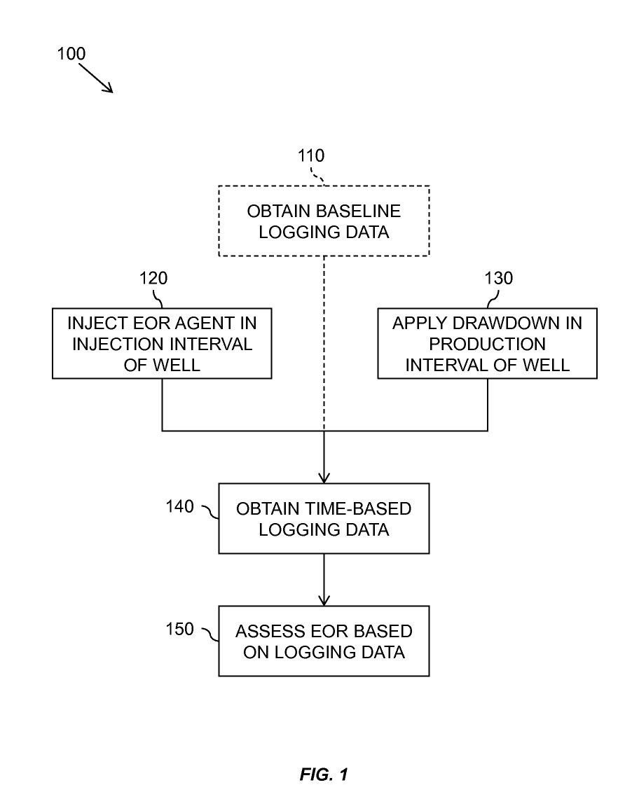

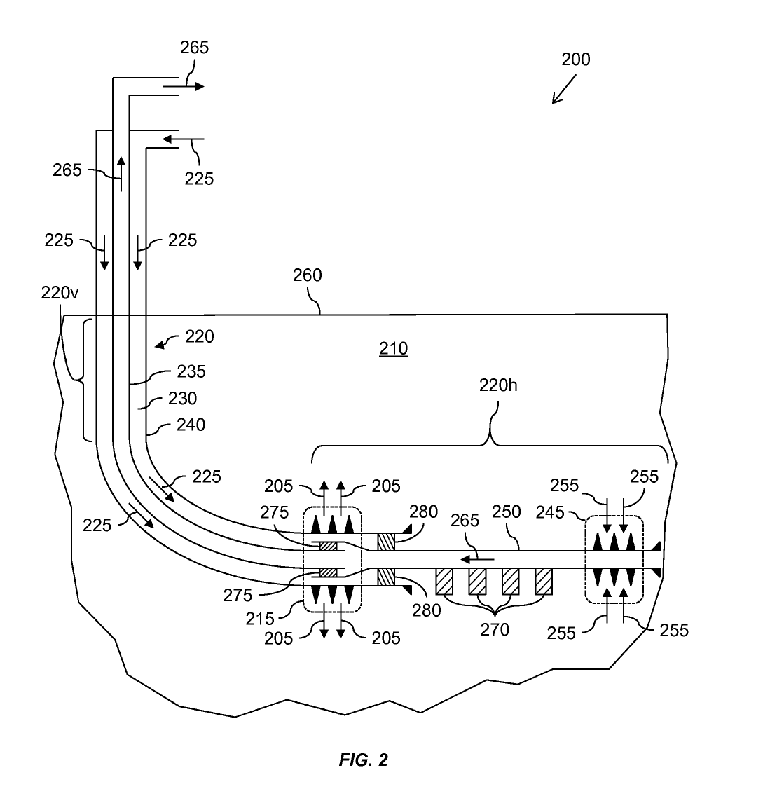

In this context, the present disclosure introduces methods and apparatus for single-well EOR. FIG. 1 is a flow-chart diagram of at least a portion of a method 100 according to one or more aspects of the present disclosure. FIG. 2 is a schematic of apparatus 200 according to one or more aspects of the present disclosure. While the following description may explicitly refer to only FIG. 1 or FIG. 2, aspects of the description may be adaptable or applicable to both FIG. 1 and FIG. 2. Thus, any of the following aspects described in reference to only one of FIG. 1 and FIG. 2, independently, may be interpreted as being described in reference to both FIG. 1 and FIG. 2 simultaneously.

Although the method 100 is depicted in FIG. 1 as being performed in a particular sequence, other sequences are also within the scope of the present disclosure. For example, one or more portions of the method 100 may be started substantially simultaneously and/or performed substantially continuously for the duration of the method 100. The method 100 may be performed utilizing an existing well 220 having at least one vertical portion 220v and at least one non-vertical (e.g., horizontal) portion 220h. Such well 220 may be established utilizing known and/or future-developed methods and/or apparatus, including drilling via rotary steerable systems for directional drilling. The separation distance between the injection interval 215 and the production interval 245 may be about 100 meters, although other distances are also within the scope of the present disclosure.

As indicated in FIG. 2 by arrows 205, the method 100 comprises injecting (120) an EOR agent into a formation 210. For example, the EOR agent may be injected into the formation 210 via perforations in an injection interval 215 of the well 220. As indicated by arrows 225, the EOR agent may be delivered to the injection interval 215 via an annulus 230 defined between the outer diameter of a completion tubing 235 and the inner diameter of a casing 240 lining at least a portion of the well 220. Alternatively, the EOR agent may be delivered to the injection interval 215 via a separate injection liner (not shown), among other delivery methods also within the scope of the present disclosure. The flow rate of the EOR agent into the formation 210 may be about proportionate to the separation distance between the injection interval 215 and the production interval 245. Injection and/or production rates may also depend on the which interval is open to flow for both injection and production intervals, characteristics of the subterranean formation, PVT (pressure, volume, temperature) properties of the EOR agent and/or formation the fluid (e.g., viscosity), and/or multiphase flow properties of the fluid-rock system (e.g., relative permeabilities and/or other EOR related interactions). The injection/production rates may vary, perhaps from about 10 barrels per day to thousands of barrels per day, although other rates are also within the scope of the present disclosure.

Injection pressure may be maintained through artificial lift hardware at the injection site, such as via downhole pumping, mechanical lift, and/or gas lift, although other means of artificial lift are also within the scope of the present disclosure. For example, if reservoir energy is insufficient, artificial lift structure installed in a vertical portion 220v of the well 220 may comprise one or more electric submersible pumps (ESPs), perhaps with a bypass configuration (e.g., utilizing a Y-tool). However, other locations uphole of the injection interval 215 may also be utilized for artificial lift. Moreover, methods within the scope of the present disclosure may lack artificial lift altogether.

The method 100 also comprises applying a drawdown (130) in the production interval 245 such that fluid from the formation 210 enters a lower completion tubing 250 via perforations therein, wherein such fluid flow is indicated in FIG. 2 by arrows 255. For example, by application of the drawdown at the production interval 245, the injected EOR agent and/or the fluid in front of it may tend to travel along the direction of the horizontal portion 220h of the well 220. The produced fluid then travels up the completion tubing 235 and 250 to the surface 260 of the well 220, as indicated in FIG. 2 by arrows 265.

Such production may be performed via a cemented liner (not shown) or a second liner. For example, the lower completion tubing 235 may comprise and/or be installed adjacent to or proximate a steel or fiberglass casing. Such casing may be cemented in place, may be installed utilizing external casing packers (ECP) 270, or may be installed utilizing both external casing packers 270 and cementing. In any case, the casing is installed in a manner which ensures crucial zonal isolation to ensure formation fluid displacement and rule out annular flow. The lower completion tubing 250 and/or adjacent or proximately installed structure may additionally comprise sliding sleeves and/or other means for sampling.

As also shown in FIG. 2, the annulus 230 that may be utilized to deliver the EOR agent to the injection interval 215 may be fluidly isolated from the completion tubing 235 and 250 via one or more packers 275, although other isolation means are also within the scope of the present disclosure. Additional packers, plugs and/or other isolation means 280 may also isolate the annulus 230 from the formation 210. Structural embodiments other than as shown in FIG. 2 are also within the scope of the present disclosure. For example, the production interval 245 may be configured uphole relative to the injection interval 215. Such configuration may reduce and/or eliminate the need for artificial lift.

The injected EOR agent injected (indicated by arrows 205 and 225 in FIG. 2) may be or comprise one or more of: fresh or saline water; foam; steam; one or more ASP (alkaline-surfactant-polymer) compositions; one or more polymer compositions; one or more designer water flooding compositions; one or more chemical agent compositions (e.g., alkali, polymers, surfactants, and/or mixtures thereof); and one or more miscible and/or immiscible gases (e.g., carbon dioxide, methane, flue gas, and/or mixtures thereof). Moreover, aspects of the present disclosure may be applicable or readily adapted to any other EOR method comprising injecting through an injection interval through the formation towards a production interval.

As depicted by dashed lines in FIG. 1, the method 100 may also comprise obtaining (110) baseline logging data. Such data may be obtained via one or more sensors. The one or more sensors may be configured to measure, detect, indicate, or otherwise obtain (hereafter collectively referred to as “obtain”) various properties, characteristics, and/or parameters of the formation 210 and/or fluid produced at the production interval 245. For example, the one or more sensors may obtain the pressure and/or flow rate of the EOR agent being injected into the formation 210 at the injection interval 215. Alternatively, or additionally, the one or more sensors may obtain the pressure of fluid in the formation 210, whether at or near the injection interval 215, at or near the production interval 245, between the injection interval 215 and the production interval 245, or elsewhere in the formation 210. Alternatively, or additionally, the one or more sensors may obtain the pressure of fluid produced at the production interval 245 inside the lower completion tubing 250. Alternatively, or additionally, the one or more sensors may be configured for utilization in transient testing between the injection interval 215 and the production interval 245.

The one or more sensors may be or comprise pressure sensors, resistivity sensors, acoustic sensors, and/or other sensors configured to obtain pressure, temperature, density, thermal conductivity, electrical conductivity, resistivity, bubble point, dew point, nuclear magnetic resonance, composition, refraction, scattering, absorption, viscosity, color, saturation, flow rate, and/or other properties, characteristics, and/or parameters of the formation 210 and/or the fluid produced at the production interval 245. The one or more sensors may alternatively or additionally comprise one or more sensors comprising or utilizing fiber-optics.

The one or more sensors may be those of one or more behind-casing logging tools, static and/or dynamic wireline logging tools, nuclear-magnetic resonance (NMR) tools, seismic tools, electromagnetic (EM) tools, and/or other known or future-developed sensing technology. For example, the one or more sensors may be those of a resistivity array tool comprising multiple electrodes or inductive elements individually controlled to generate and measure currents in the formation 210. One such tool may be operable to obtain resistance at various radial depths, where the distances between the electrodes or inductive elements may be adjusted to enable a sufficiently deep penetration of the sensing field of the tool (e.g., about one meter radially outward from the tool into the formation 210), resulting in a three-dimensional map of the resistivity distribution around the well 220. A resistivity tool may also be utilized to obtain a two-dimensional slice of the formation 210 between the injection interval 215 and the production interval 245, whether as an alternative to or in addition to the three-dimensional map. Instead of (or in addition to) the resistivity array tool, which is sensitive to the electromagnetic field in the formation 210, a sonic array tool may be utilized to detect acoustic waves in the formation. For example, when monitoring gas injection fronts, which have a high contrast in acoustic impedance, sonic or seismic arrays may be more effective than electromagnetic tools. An array of sensors, such as hydrophones or geophones, may also or alternatively be placed in the well 220 to, for example, passively monitor the progress of the fluid fronts. The one or more sensors may alternatively or additionally be otherwise temporarily or permanently installed outside the casing 240, the lower completion tubing 250, and/or the casing, lining, and/or other structure installed adjacent to or proximate the lower completion tubing 250. The one or more sensors may alternatively or additionally be temporarily or permanently installed at or near the surface 260 of the well 220, whether as integral to the associated surface equipment (not shown) or as stand-alone equipment.

Additional or complementary measuring devices may be installed either downhole or at the surface 260. Such devices may include flow meters configured to monitor the flow rates and/or composition of the various phases injected and produced. For example, a multi-phase flow meter at the surface 260 (not shown) may be utilized to monitor the composition and/or flow rates of the produced fluids. These flow meters may be tuned to measure the flow rate of the production stream, perhaps targeting specific elements injected within the EOR fluid. Where any of the sensors and/or other measuring devices comprises source-receiver combinations (e.g., NMR, EM, etc.), additional sources and/or receivers for the associated sensing field may be installed on the surface 260 and/or in neighboring wells. Additional or complimentary devices which may be installed downhole or at the surface 260 may also be utilized when adapting standard seismic methods, such as vertical seismic profiling (VSP), in which case a controlled seismic source may be positioned downhole or at the surface 260 to generate acoustic energy which is then reflected from the fluid front and registered by the array tool(s).

In another example (not shown), the well 220 may be divided into a number of zones and/or sections and, while the EOR agent is injected, the EOR agent is marked by specific tracers with unique characteristics for each zone/section. The tracers may be immobilized or placed with the completions in each zone/section. The tracers may be specific, such as to give specific information from each zone/section. A location-specific measurement of the EOR agent and/or formation fluid front may be made utilizing a device capable of measuring a concentration profile for each tracer along the length of the well 220, such as by utilizing an array of stationary sensors mounted on the completion tubing 235 and/or 250 and/or or a logging tool configured for conveyance along the well 220.

Regardless of whether the method 100 includes the baseline measurement (110), the method 100 may comprise obtaining (140) time-based logging data. For example, the above-described one or more sensors and/or tools may be utilized to obtain various properties, characteristics, and/or parameters (such as those described above) at predetermined or otherwise selected time intervals. The information obtained during the time-based logging (140), and the frequency at which such information is obtained, may vary within the scope of the present disclosure. For example, obtaining (140) time-based logging data may comprise running one or more logging tools at certain intervals (e.g., weekly) to obtain data which, when processed, allows observing a gas front progression.

At least some of the information obtained during the time-based logging (140) may be utilized to assess (150) the effectiveness of the EOR agent injection. One or more conventional or future-developed processes may be utilized to assess the effectiveness of the EOR agent injection. For example, the assessment (150) may comprise one or more log interpretation techniques, as well as combined inversion using analytical and numerical methods.

The result of the assessment (150) and, hence, the method 100, may vary within the scope of the present disclosure. For example, the assessment (150) may assess (or obtain, determine, and/or calculate, herein referred to collectively as “assess”) incremental recovery, displacement efficiency, flood front(s) progression, and/or the impact of heterogeneities of the formation 210 on EOR effectiveness. The assessment (150) may alternatively or additionally assess oil bank development, EOR agent performance and degradation, and/or mobilized oil recovery (e.g., change in saturation).

The depth of investigation of one or more methods within the scope of the present disclosure may not be sufficient to cover the entire region or volume between the injection interval 215 and the production interval 245. Thus, while the efficiency of an EOR method can be estimated from measurements made in just a part of the swept volume, it may sometimes be more accurate to consider the total swept volume in relation with the total production from such volume. To perform a more accurate determination of the recovery rate of a tested EOR method, the measurements made downhole or at the surface 260 during the time-based logging (140) may be utile as input to a reservoir model which, in turn, delivers an estimate of the parameters sought.

Thus, the EOR assessment (150) may include the calculation of recovery factors and determination of other formation parameters, which may rely on the utilization of a reservoir simulator, reservoir modeling software, or a combination thereof. Inputs for such simulation may comprise the geometry of the well 220 and any measurements that may be made to determine the geology, lithography, porosities, saturations, and/or the flow paths of the fluids in the formation, which may be included in and/or derived from the baseline (110) and/or time-based (140) logging data.

For example, when using the baseline (110) and/or time-based (140) logging data to constrain a reservoir model, it may be possible to arrive at a more accurate determination of the swept volume. That is, the measured data may be used as an indicator of sweep efficiency and compared to what would be obtained at this stage of the injection process (i.e., for the same total volume of fluid injected so far), although perhaps assuming a constant permeability distribution. The result may then be inverted to change the permeability map to, for example, increase the permeability in zones that are poorly swept compared to the uniform assumption. From there, a more accurate simulation may be performed utilizing the reservoir simulator.

The injected and produced volumes of oil, gas, water, and/or EOR agent may be measured downhole and/or at the surface 260. Using a simulation as described above, one may model the formation volume that is swept with the amount of EOR agent going in various zones as calibrated by the baseline (110) and/or time-based (140) logging data. The EOR assessment (150) may thus include estimating a recovery factor for the center of the swept zone, which may enable an estimation of recovery at a larger scale (e.g., full field implementation).

By utilizing one or more aspects described above, it may be possible to determine, for example, whether a treatment which changes the wettability of the formation 210 results in an improved recovery rate. Of course, other similar decisions relevant to the production of a hydrocarbon reservoir may also be enabled by one or more aspects of the present disclosure. For example, for an old producing well in a completely swept zone (e.g., after water breakthrough), the residual oil saturation around the well may not be representative of the remaining oil saturation in most parts of the swept zone. The oil recovery achieved at this stage of the life of a producing well may be close to the maximum reachable under plain sea-water injection or whatever injection fluid was used. Testing the EOR treatment according to one or more aspects of the present disclosure may provide a direct quantitative measurement of the incremental oil recovery that can be obtained by the tested treatment.

One or more aspects of the present disclosure may also be favorable over conventional EOR pilots involving well-known patterns (e.g., the five-spot pattern described above) and/or conventional injection-production schemes. For example, one or more aspects of the present disclosure may not merely simplify the pilot design by involving a single well instead of multiple injection/production wells, but may also accelerate EOR performance assessment to enable a shorter time frame than previously encountered with conventional injection-production schemes. For example, by utilizing one or more aspects of the present disclosure, the total pumping time for the EOR assessment may be reduced by about 70%, and/or the total volume of EOR agent injected during the EOR injection (120), and the cost thereof, may be reduced by about 70%. However, other reduction levels are also within the scope of the present disclosure.

In view of all of the above and the figures, one of ordinary skill in the art should readily recognize that the present disclosure introduces a method comprising: injecting an enhanced oil recovery (EOR) agent into a subterranean formation in at least one injection interval of a hydrocarbon well extending into the subterranean formation; producing fluid from the formation from at least one production interval of the hydrocarbon well; obtaining logging data associated with at least one of the formation, the injected EOR agent and the produced fluid; and assessing effectiveness of the EOR agent based on the obtained logging data. The EOR agent may comprise at least one of: fresh water; saline water; foam; steam; at least one alkaline-surfactant-polymer (ASP) composition; at least one polymer composition; at least one designer water flooding composition; at least one chemical agent composition; at least one miscible gas; and at least one immiscible gas. The at least one chemical agent composition may comprise at least one of: at least one alkali; at least one polymer; at least one surfactant; a combination of at least one alkali and at least one polymer; a combination of at least one polymer and at least one surfactant; a combination of at least one alkali and at least one surfactant; and a combination of at least one alkali, at least one polymer and at least one surfactant. The at least one miscible gas or the at least one immiscible gas may comprise at least one of: carbon dioxide; methane; flue gas; a combination of carbon dioxide and methane; a combination of methane and flue gas; a combination of carbon dioxide and flue gas; and a combination of carbon dioxide, methane and flue gas.

Injecting the EOR agent into the subterranean formation at the at least one injection interval may comprise pumping the EOR agent from a surface of the hydrocarbon well to the at least one injection interval via an annulus defined between an inner diameter of the hydrocarbon well (or a casing or other lining thereof) and an outer diameter of a completion tubing positioned in the hydrocarbon well. Injecting the EOR agent into the subterranean formation at the at least one injection interval may comprise pumping the EOR agent through a plurality of perforations in a completion tubing positioned in the hydrocarbon well, wherein the plurality of perforations may be adjacent or within the at least one injection interval.

Producing fluid from the formation from the at least one production interval of the hydrocarbon well may comprise reducing a pressure within a completion tubing positioned in the hydrocarbon well thus encouraging fluid to flow from the subterranean formation into the completion tubing via perforations in the completion tubing adjacent or within the at least one production interval. Producing fluid from the subterranean formation at the at least one production interval of the hydrocarbon well may comprise artificially lifting the produced fluid. Artificially lifting the produced fluid may comprise pumping the produced fluid using an electric submersible pump (ESP) positioned in the hydrocarbon well. Artificially lifting the produced fluid may comprise injecting gas into the produced fluid.

Obtaining logging data may comprise obtaining data comprising or indicating at least one of: pressure, temperature, density, thermal conductivity, electrical conductivity, resistivity, bubble point, dew point, nuclear magnetic resonance, composition, refraction, scattering, absorption, viscosity, color, saturation, flow rate and/or other properties, characteristics and/or parameters of the subterranean formation and/or the fluid produced at the at least one production interval. Obtaining logging data may comprise operating at least one of: a behind-casing logging tool; a static wireline logging tool; a dynamic wireline logging tool; a nuclear magnetic resonance (NMR) tool; a seismic tool; an electromagnetic (EM) tool; a resistivity tool; and a plurality of hydrophones and/or geophones positioned within the hydrocarbon well and/or at the surface of the hydrocarbon well. Obtaining logging data may utilize at least one sensor. The at least one sensor may be installed in the hydrocarbon well. The at least one sensor may be installed behind a casing and/or other lining along at least a portion of the hydrocarbon well.

Assessing effectiveness of the EOR agent based on the obtained logging data may comprise utilizing at least one of: a reservoir simulation model; and modeling software. Assessing effectiveness of the EOR agent based on the obtained logging data may comprise utilizing one or more log interpretation techniques. Assessing effectiveness of the EOR agent based on the obtained logging data may comprise utilizing a combined inversion using analytical and numerical methods.

The method may further comprise obtaining baseline logging data prior to commencing injecting the EOR agent and producing fluid from the subterranean formation. Injecting the EOR agent and producing fluid from the formation may be performed simultaneously and continuously during a period of time. Obtaining the logging data may be performed at regular or irregular time intervals during the period of time. Assessing effectiveness of the EOR agent may be repeated during each time interval.

The present disclosure also introduces a system comprising: means for injecting an enhanced oil recovery (EOR) agent into a subterranean formation in at least one injection interval of a hydrocarbon well extending into the subterranean formation; means for producing fluid from the formation from at least one production interval of the hydrocarbon well; means for obtaining logging data associated with at least one of the formation, the injected EOR agent and the produced fluid; and means for assessing effectiveness of the EOR agent based on the obtained logging data. The obtained logging data may comprise data indicating at least one of: pressure, temperature, density, thermal conductivity, electrical conductivity, resistivity, bubble point, dew point, nuclear magnetic resonance, composition, refraction, scattering, absorption, viscosity, color, saturation, and flow rate.

The present disclosure also introduces an apparatus comprising: a completion installed in a single hydrocarbon well extending into a subterranean formation, wherein the completion comprises: an uphole completion comprising a plurality of perforations for injecting an EOR agent pumped from surface into the subterranean formation; and a downhole completion comprising a plurality of perforations for producing fluid from the subterranean formation in response to injection of the EOR agent. The apparatus may further comprise at least one sensor for obtaining data comprising or indicating at least one of: pressure, temperature, density, thermal conductivity, electrical conductivity, resistivity, bubble point, dew point, nuclear magnetic resonance, composition, refraction, scattering, absorption, viscosity, color, saturation, flow rate and/or other properties, characteristics and/or parameters of the subterranean formation and/or the fluid produced at the downhole completion.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A method, comprising:
injecting an enhanced oil recovery (EOR) agent into a subterranean formation in at least one injection interval of a hydrocarbon well extending into the subterranean formation;
producing fluid from the formation from at least one production interval of the hydrocarbon well;
obtaining logging data associated with at least one of the formation, the injected EOR agent, and the produced fluid; and
assessing effectiveness of the EOR agent based on the obtained logging data.

2. The method of claim 1 wherein the EOR agent comprises at least one of:
fresh water;
saline water;
foam;
steam;
an alkaline-surfactant-polymer (ASP) composition;
a polymer composition;
a water flooding composition;
a chemical agent composition;
a miscible gas; and
an immiscible gas.

3. The method of claim 2 wherein the chemical agent composition comprises at least one of:
an alkali;
a polymer;
a surfactant;
a combination of an alkali and a polymer;
a combination of a polymer and a surfactant;
a combination of an alkali and a surfactant; and
a combination of an alkali, a polymer, and a surfactant.

4. The method of claim 2 wherein at least one of the miscible gas and the immiscible gas comprises at least one of:
carbon dioxide;
methane;
flue gas;
a combination of carbon dioxide and methane;
a combination of methane and flue gas;
a combination of carbon dioxide and flue gas; and
a combination of carbon dioxide, methane and flue gas.

5. The method of claim 1 wherein injecting the EOR agent into the subterranean formation in the at least one injection interval comprises pumping the EOR agent from a surface of the hydrocarbon well to the at least one injection interval via an annulus partially defined by an outer diameter of a completion tubing positioned in the hydrocarbon well.

6. The method of claim 1 wherein injecting the EOR agent into the subterranean formation in the at least one injection interval comprises pumping the EOR agent through a plurality of perforations in a completion tubing positioned in the hydrocarbon well, wherein the plurality of perforations are adjacent or within the at least one injection interval.

7. The method of claim 1 wherein producing fluid from the formation from the at least one production interval of the hydrocarbon well comprises encouraging fluid to flow from the subterranean formation into a completion tubing positioned in the hydrocarbon well, via perforations in the completion tubing adjacent or within the at least one production interval, by reducing a pressure within the completion tubing.

8. The method of claim 1 wherein producing fluid from the subterranean formation from the at least one production interval of the hydrocarbon well comprises artificially lifting the produced fluid.

9. The method of claim 1 wherein obtaining logging data comprises obtaining data comprising or indicating at least one of: pressure, temperature, density, thermal conductivity, electrical conductivity, resistivity, bubble point, dew point, nuclear magnetic resonance, composition, refraction, scattering, absorption, viscosity, color, saturation, and flow rate.

10. The method of claim 1 wherein obtaining logging data comprises operating at least one of:
a behind-casing logging tool;
a static wireline logging tool;
a dynamic wireline logging tool;
a nuclear magnetic resonance (NMR) tool;
a seismic tool;
an electromagnetic (EM) tool;
a resistivity tool;
a plurality of hydrophones positioned within the hydrocarbon well;
a plurality of hydrophones positioned at the surface of the hydrocarbon well;
a plurality of geophones positioned within the hydrocarbon well; and
a plurality of geophones positioned at the surface of the hydrocarbon well.

11. The method of claim 1 wherein obtaining logging data utilizes at least one sensor permanently installed in the hydrocarbon well.

12. The method of claim 1 wherein obtaining logging data utilizes at least one sensor installed behind a casing of the hydrocarbon well.

13. The method of claim 1 wherein assessing effectiveness of the EOR agent based on the obtained logging data comprises utilizing at least one of:
a reservoir simulation model;
modeling software;
a log interpretation technique; and
a combined inversion using analytical and numerical methods.

14. The method of claim 1 further comprising obtaining baseline logging data prior to commencing injecting the EOR agent and producing fluid from the subterranean formation.

15. The method of claim 1 wherein injecting the EOR agent and producing fluid from the formation are performed simultaneously and continuously during a period of time.

16. The method of claim 15 wherein obtaining the logging data is performed at regular time intervals during the period of time, and wherein assessing effectiveness of the EOR agent is repeated during each time interval.

17. A system, comprising:
means for injecting an enhanced oil recovery (EOR) agent into a subterranean formation in at least one injection interval of a hydrocarbon well extending into the subterranean formation;
means for producing fluid from the formation from at least one production interval of the hydrocarbon well;
means for obtaining logging data associated with at least one of the formation, the injected EOR agent, and the produced fluid; and
means for assessing effectiveness of the EOR agent based on the obtained logging data.

18. The system of claim 17 wherein the obtained logging data comprises data indicating at least one of: pressure, temperature, density, thermal conductivity, electrical conductivity, resistivity, bubble point, dew point, nuclear magnetic resonance, composition, refraction, scattering, absorption, viscosity, color, saturation, and flow rate.

19. An apparatus, comprising:
a completion installed in a single hydrocarbon well extending into a subterranean formation, wherein the completion comprises:
an uphole completion comprising a plurality of perforations for injecting an EOR agent pumped from surface into the subterranean formation; and
a downhole completion comprising a plurality of perforations for producing fluid from the subterranean formation in response to injection of the EOR agent.

20. The apparatus of claim 19 further comprising at least one sensor for obtaining data indicating at least one of: pressure, temperature, density, thermal conductivity, electrical conductivity, resistivity, bubble point, dew point, nuclear magnetic resonance, composition, refraction, scattering, absorption, viscosity, color, saturation, and flow rate.
